(19) United States
(12) Patent Application Publication
(10) Pub. No.: US 2019/0116138 A1
(43) Pub. Date: Apr. 18, 2019

(54) METHOD OF PROCESSING MESSAGES IN A COMMUNICATION DEVICE

(71) Applicant: Siilo Holding B.V., Amsterdam (NL)

(72) Inventors: Joost Pieter BRUGGEMAN, Amsterdam (NL); Keith Albert BANKS, Amsterdam (NL); Jasper Erik AARTS, Amsterdam (NL)

(21) Appl. No.: 15/785,965

(22) Filed: Oct. 17, 2017

(51) Int. Cl. H04L 12/58

(52) U.S. Cl. CPC H04L 51/04; H04L 51/12; H04L 51/16

(57) ABSTRACT

A method is provided for providing a message in a child message thread for, for example, an instant message application. The child message thread is associated with a parent thread and preferably with a participant list that comprises at least details of one sender and a receiver of messages of the parent thread and the child thread. In a parent display screen, parent messages may be provided, sorted with objects representing a child thread. By selecting the child thread, messages in the child thread are shown. This concept of nesting of child conversations in a parent conversation allows for convenient and efficient organisation of messages for participants.

### FIELD OF THE INVENTION

The various aspects and embodiments thereof relate to methods for processing messages in a communication device, grouping and displaying messages and devices for executing such methods.

### BACKGROUND

Instant message exchange applications, in particular for mobile devices, allow creation of ad hoc 1-to-1 as well as group conversations. In such ad hoc communications, various participants may share messages with one another. At the top hierarchical level, group conversations are shown along with one on one conversations. In groups as well as 1-to-1 conversations a lot of different topics may be discussed and it is common for multiple topics to be discussed at the same time, making this prone to errors in interpretation who is responding to what topic.

### SUMMARY

It is preferred to provide a more efficient grouping of messages, optionally per topic, for exchange by instant messaging applications. When instant messaging applications are applied in industries that are sensitive to these errors, i.e. where such errors can have dramatic outcomes such as healthcare, there is a need for these unstructured multiple topics to become structured and fully threaded conversations.

One aspect provides, in an electronic communication device comprising a memory, a method of processing data messages. The method comprises receiving a user selection of a parent message thread comprising parent messages stored in the memory of the communication device receiving a request for creating a child message thread associated with the parent message thread and, upon receiving the request, creating a child message thread object. The method further comprises associating the child thread object to the parent message thread, receiving a user input for displaying objects in the parent message thread, providing, for display on the screen, parent display objects representing the parent messages in accordance with a display rule; and providing for display on the screen, a child thread display object representing the child thread with the parent display objects in accordance with the display rule.

This concept of nesting of child conversations in a parent conversation allows for convenient and efficient organisation of messages for participants. Rather than having threads in threads directly displayed with staggered margins, in one and the same view, a user will not be confused by data other than being associated with a particular thread.

An embodiment further comprises receiving a selection of the child thread, providing, for display on the screen, messages of the child thread, receiving user input for a new message in the child thread, providing, for display on the screen, the new message in the child thread and sending, via a communication module comprised by the communication device, the new message to participants comprised by a participant list associated with at least one of the child thread and the parent thread, the new message comprising a parent thread identifier and a child thread identifier.

After creation of a child conversation thread at a first device, messages may be created in the child conversation. Theses messages may subsequently be shared with other members of the participant list. Preferably, one participant list comprising one or more participants other than the sending party, is associated with a parent thread comprising one or more child threads and with all child threads in the parent thread.

In another embodiment, each of the parent messages and the child thread have a time associated with them and the display rule comprising a requirement to sort message by time stamp value.

Such embodiment provides efficient an convenient sorting of message data.

In a further embodiment, the time stamp associated with the child thread is the time stamp of one of the latest received and the latest created message in the child thread.

This embodiment shows information received in a convenient way. Continuing maintaining a time stamp value for the child thread object at which the child thread object was created is less convenient. Rather, it is convenient to adjust the time as indicated, which allows convenient access in a user interface to the latest messages in child threads.

A second aspect provides, in an electronic communication device comprising a memory and a display screen, a method of processing data messages. The method comprises receiving a message comprising a parent thread identifier and a child identifier, obtaining a child thread object with an association with the child identifier, associating the message with the child thread object, receiving a user input for displaying objects in the parent thread, providing for display, on the screen, parent display objects representing the parent messages in accordance with a display rule related to object properties and providing for display, on the screen, a child thread display object representing the child thread with the parent display objects in accordance with the display rule.

This aspect provides a method for processing received child messages and child thread objects for convenient and well-organised display.

An embodiment further comprises obtaining a timestamp associated with the message; and associating the timestamp with the child thread object. In this embodiment, the display rule comprises a requirement to sort messages by time stamp value.

This embodiment shows information received in a convenient way. Continuing maintaining a time stamp value for the child thread object at which the child thread object was created is less convenient. Rather, it is convenient to adjust the time as indicated, which allows convenient access in a user interface to the latest messages in child threads.

A third embodiment comprises computer program product comprising computer executable code enabling a computer when programmed by means of the computer executable code to execute the method according to the first aspect. The computer program product may be stored on a non-transient medium.

A fourth embodiment comprises computer program product comprising computer executable code enabling a computer when programmed by means of the computer executable code to execute the method according to the second aspect. The computer program product may be stored on a non-transient medium.

A fifth embodiment provides an electronic communication device. The device comprises a memory, a user input module; and a processing unit. In the device, the user input module is arranged to receive a user selection of a parent message thread comprising parent messages stored in the memory of the communication device; and receive a user request for creating a child message thread associated with the parent message thread. The processing unit is arranged to upon receiving the request, create a child message thread object, associate the child thread object to the parent message thread, receive a user input for displaying objects in the parent message thread, cause a screen to display parent display objects representing the parent messages in accordance with a display rule and cause the screen to display a child thread display object representing the child thread with the parent display objects in accordance with the display rule.

A sixth embodiment provides an electronic communication device. The device comprises a user input module and a processing unit. The processing unit is arranged to receive a message comprising a parent thread identifier and a child identifier, obtain a child thread object with an association with the child identifier, associate the message with the child thread object, receive, via the user input module, a user input for displaying objects in the parent thread, cause a display screen to display parent display objects representing the parent messages in accordance with a display rule related to object properties; and cause the screen to display a child thread display object representing the child thread with the parent display objects in accordance with the display rule.

### BRIEF DESCRIPTION OF THE DRAWINGS

The various aspects and embodiments thereof will now be discussed in further detail in conjunction with drawings. In the drawings:

FIG. 1: shows a communication system;

FIG. 2: shows a first flowchart;

FIG. 3: shows a second flowchart;

FIG. 4 A: shows a first user interface;

FIG. 4 B: shows a second user interface; and

FIG. 4 C: shows a third user interface.

### DETAILED DESCRIPTION

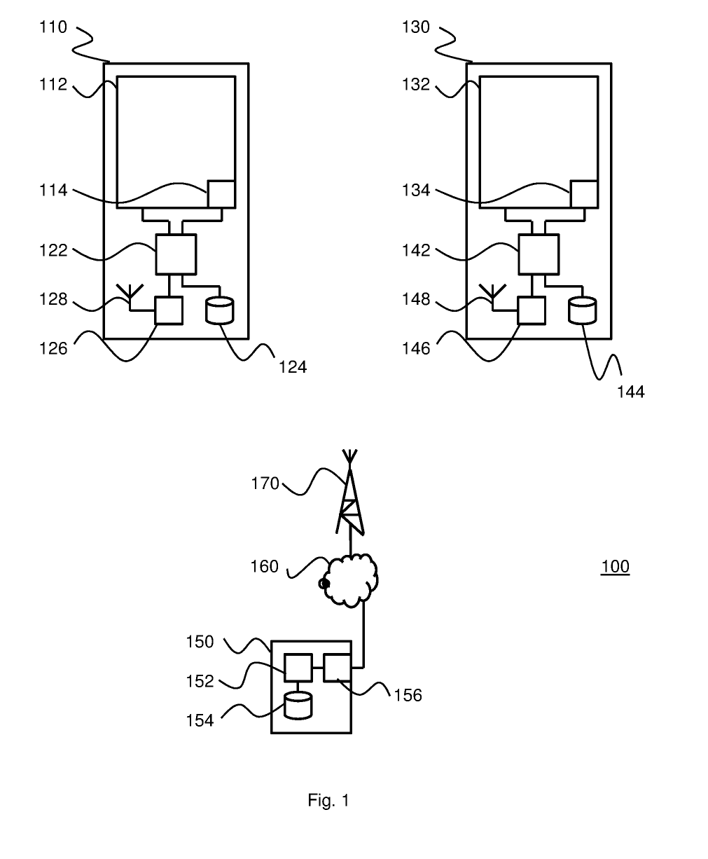

FIG. 1 shows a mobile communication system 100. The mobile communication system 100 comprise a first user equipment 110, a second user equipment 130, an base station 170, a network 160 and a server 150. The first user equipment 110 and the second user equipment 130 are operationally connected via the base station 170, the network 160 and the server 150. The base station 170 may be a single base station, alternatively is may be two or more base stations as part of one or more cellular communication networks or other wireless communication network or networks. In yet another embodiment, the first user equipment 110 and the second user equipment 130 are connected over a wired or hybrid-wired and wireless-connection. The network 160 may be any type of network and is preferably a worldwide TCP/IP based network.

In the embodiment shown here, the first user equipment 110 and the second user equipment 130 are shown a identical entities; in another embodiment, they may be different devices from different manufacturers, arranged for either wired or wireless communication

The first user equipment 110 comprises a display screen 111 comprising a touch screen module 114. The touch screen module 114 arranged the display screen 110 to function as an input device and a touch screen in particular. In another embodiment, additionally or alternatively, the first user equipment comprises physical buttons or other physical dedicated input elements for receiving user input.

The first user equipment further comprises a processing unit 122, a storage module 124 and a communication module 126. The processing module 122 is arranged for processing data received by the first user equipment 110 via the touch screen module 114 or via the communication module 126. Furthermore, the processing module 122 is arranged to control the various parts of the first user equipment 110.

The memory module 124 may comprise volatile memory, non-volatile memory, other types of memory or a combination thereof. The memory module 124 is arranged for storing user data, like messages, applications and the like and for storing basic software for controlling operation of the first user equipment 110.

The communication module 126 is arranged for sending data to the base station 170 and for receiving data from the base station 170. To that purpose, the communication module 126 comprises one or more transceivers arranged to operate in accordance with a wireless data communication standard like GSM, GPRS, 3G, WCDMA, LTE, HSDPA, WiMAX, Wi-Fi (IEEE 802.11), Bluetooth, other or a combination thereof. For sending and receiving radio signals, the communication module is connected to one or more antennae 128.

The second user equipment 130 comprises a display screen 132 comprising a touch screen module 134. The touch screen module 134 arranged the display screen 130 to function as an input device and a touch screen in particular. In another embodiment, additionally or alternatively, the second user equipment comprises physical buttons or other physical dedicated input elements for receiving user input.

The second user equipment further comprises a processing unit 142, a storage module 144 and a communication module 146. The processing module 142 is arranged for processing data received by the second user equipment 130 via the touch screen module 134 or via the communication module 146. Furthermore, the processing module 142 is arranged to control the various parts of the second user equipment 130.

The memory module 144 may comprise volatile memory, non-volatile memory, other types of memory or a combination thereof. The memory module 144 is arranged for storing user data, like messages, applications and the like and for storing basic software for controlling operation of the second user equipment 130.

The communication module 146 is arranged for sending data to the base station 170 and for receiving data from the base station 170. To that purpose, the communication module 146 comprises one or more transceivers arranged to operate in accordance with a wireless data communication standard like GSM, GPRS, 3G, WCDMA, LTE, HSDPA, WiMAX, Wi-Fi (IEEE 802.11), Bluetooth, other or a combination thereof. For sending and receiving radio signals, the communication module is connected to one or more antennae 148.

The server 150 comprises a server processing module 152 for processing data to be sent and received by means of a server communication module 156 from the network 160. Furthermore, the server processing module 156 is arranged for controlling operation of the various components of the server 150. Processed data and data to be processed as well as data received and data to be sent may be stored in a server memory module 154. The server memory module 154 may also hold computer executable code for programming the server processing module 152.

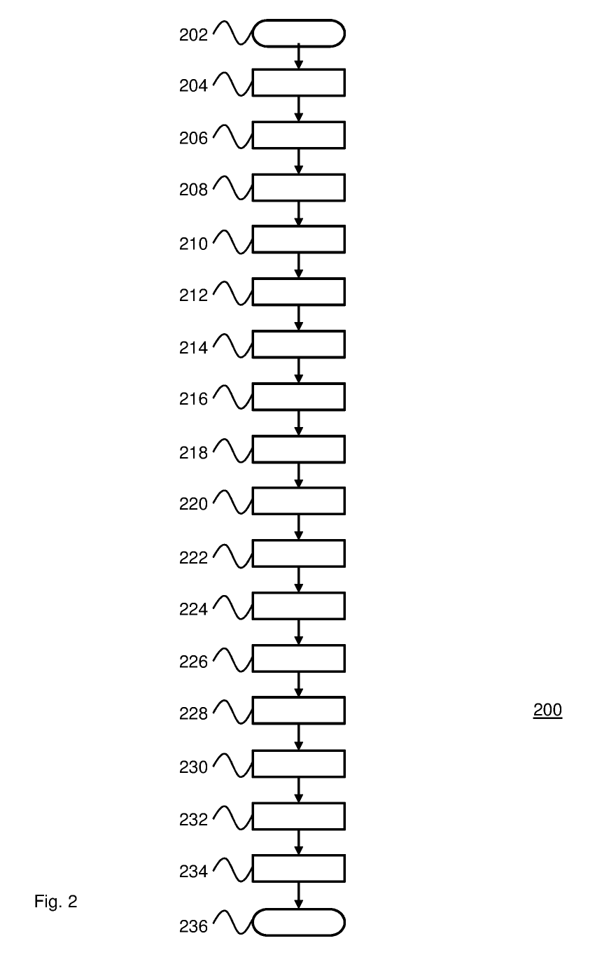

FIG. 2 shows a first flowchart 200 depicting a method that may be performed by the first user equipment 110. The various part of the first flowchart 200 are briefly summarised directly below and will subsequently be discussed in further detail.
202: start procedure
204: receive selection parent thread
206: receive instruction creation child thread
208: create child thread object
210: associate child thread object with patent thread
212: receive user message data for child thread
214: create message
216: provide message with timestamp
218: associate the timestamp with child object
220: display child thread
222: receive hierarchy up instruction
224: obtain objects in parent thread
226: sort objects in parent thread
228: display sorted objects
230: associate new message with child thread object identifier
232: associate new message with parent thread object identifier
234: send new message
236: end procedure

The procedure starts in a terminator 202 and continues to step 204 in which a selection of a parent thread is received. A parent thread is a thread provided at a top level of a message sharing application. The parent thread preferably has a specific group of participants associated with it. Over time, participants may be added to or removed from the group, the distribution list for messages in a parent thread is determined by the participant group list associated with the thread rather than with a specific message.

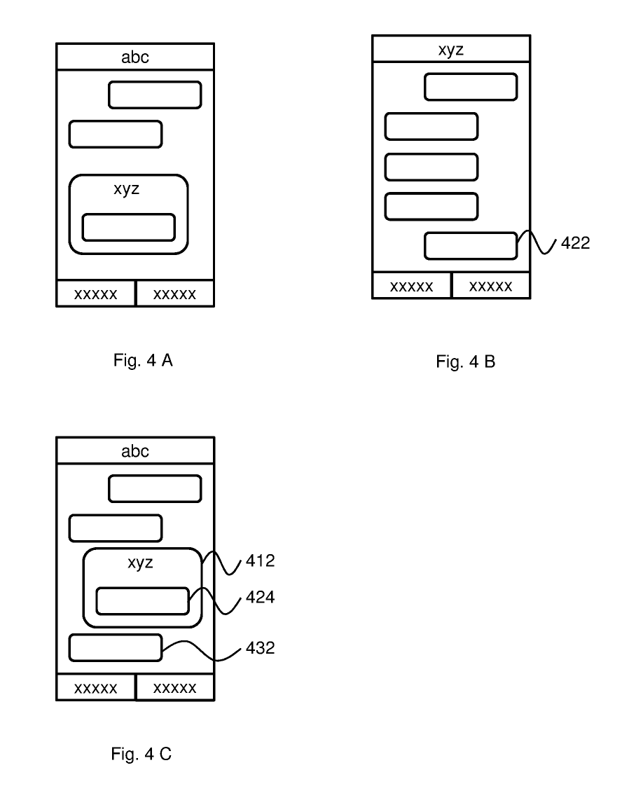

In step 206, an instruction for creation of a child thread is received. The instructions are preferably received by means of the touch screen module 114 as input module for the first user equipment 110. In step 208, the child message thread object is created and in step 210, the child message thread is associated with the parent thread selected previously. The child message thread object may be visualised in the parent thread as an object identified “xyz” in the parent thread, in line with messages comprised by the parent thread; this is shown by FIG. 4 A.

In step 212, the first user equipment 110 receives message data from a user by means of the touch screen module 114. This may be alphanumerical text, emoticons, icons, an image, an audio object, an audio-visual object, data objects, other, or a combination thereof. With this data, a child message 422 for the child thread xyz is created in step 214, as shown in FIG. 4 B.

In step 216, the child message 422 is provided with a timestamp. This timestamp may be based on a local time, optionally provided with location information like time zone information. Additionally or alternatively, a standard time like GMT may be set as timestamp. In step 218, the time stamp of the newly created child message is associated with the child thread object. In step 220, the child thread with its messages is shown on the screen 112 of the first user equipment 110.

Subsequently, in step 222, an instruction may be received by an input element of the first user equipment 110 to go one hierarchical level up in the messaging application. In this particular scenario, with the content of the child thread shown, the content of the parent thread is to be shown. For showing the parent thread, objects to be shown, messages and child conversation objects, are retrieved in step 224, for example from the memory module 124.

In step 226, the objects retrieved are sorted. The sorting takes in this embodiment place by timestamp associated with objects. Messages of the parent thread have a timestamp associated with them, which may have been received with the message, created upon receiving the message, created by an intermediate message server upon forwarding, other, or a combination thereof. In step 228, the objects of the parent thread are sorted. In this embodiment, a new message has been received for the parent conversation after creation of the child message. Hence, as shown by FIG. 4 C, the child conversation object 412 representing the child conversation created, is sorted behind a newly received message 432. The child conversation objet 412 is in this embodiment shown with a child message content object 424, which may contain at least some text of at least one, preferably the latest, child message.

In step 230, the child message is associated with a parent thread identifier, identifying the parent thread abc and in step 232, a child thread identifier identifying the child thread xyz is associated with the child message. In one embodiment, the parent thread identifier may be derived from the child thread identifier. In that case, step 230 may be omitted. Subsequently, in step 234, the child message is sent to the second user equipment 130, either directly or via the server 150. Subsequently, the procedure ends in a terminator 236.

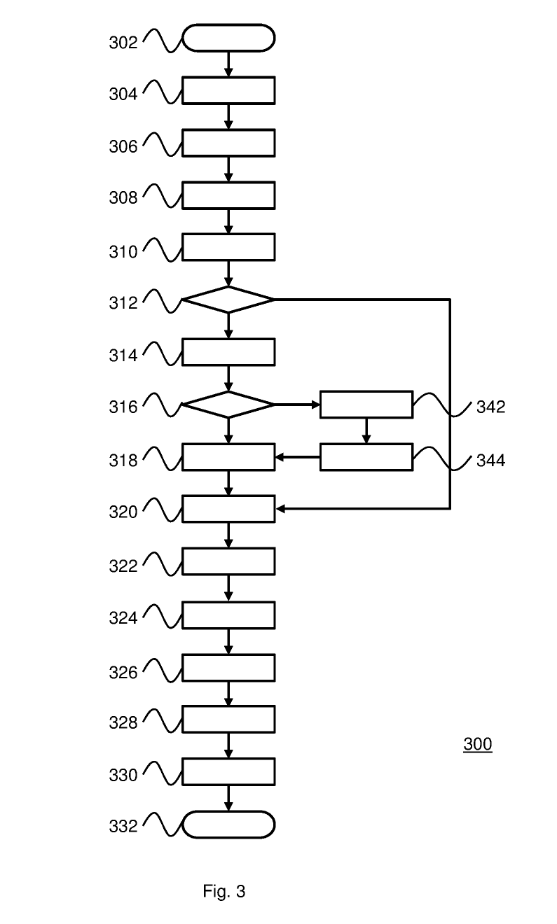

FIG. 3 shows a second flowchart 300 depicting a procedure for receiving the newly created child message and for handling the message by the second user equipment 130. The various parts of the third flowchart 300 are briefly summarised below and subsequently discussed in further detail.
302: start procedure
304: receive child message
306: check parent ID
308: check child ID
310: obtain time stamp
312: child object in message?
314: search memory for child object
316: child object found?
318: associate child message with retrieved child object
320: notify user of receipt of child message
322: receive child message display command
324: display child thread with new message
326: receive hierarchy up command
328: obtain objects in parent thread
330: sort objects in parent thread
332: display sorted objects
334: end procedure
342: create child thread object
344: associate identifier received with created create child thread object

The procedure starts in a terminator 302 and proceeds to step 304 in which a child thread message is received. In step 306, the parent identifier of the received message is checked and obtained and in step 308, the child identifier of the received message is checked and obtained. If the parent thread identifier is embedded in the child thread identifier, step 306 may be omitted.

In step 310, a timestamp for the received message is obtained. The timestamp may be comprised by the received message or, alternatively or additionally, created by the second user equipment 130 upon receiving the message. In step 312, the second user equipment 130 and the processing module 142 in particular checks whether a child thread object is available in the message. Such child thread object may be sent by the first user equipment 110 or the server 150 and may comprise a participant list, for example of the parent thread, an image data object, a description of the child thread, a list of at least some child message, other, or a combination thereof. The child thread object may be sent to every participant or, alternatively, only to participant receiving a child message for a particular child thread for the first time.

If the child data object is not available in the received message, the procedure continues by searching the memory module 144 for a child data object matching the retrieved child identifier for the received message. If not child data object is found, a child thread object is created in step 342 and associated with the child thread identifier received in step 344. If the child thread object is found in the memory module 144 in step 314, the procedure proceeds in step 316 directly to step 318 in which the child message is associated with the retrieved child object. In yet another alternative, a child thread object is requested from the server 150 upon receiving a child message or, alternatively or additionally, upon detecting no child thread object is available in the second user equipment 130.

It is noted that step may be switched in the sense that first the memory is search for the applicable child thread object, if no object is retrieved, the message is checked for object data and if in that case no child thread object is obtained, a child object is created.

Subsequently, the procedure proceeds to step 320, in which the user of the second user equipment 130 is informed of the receipt of a message. If it is determined in step 312 that the child data object is available in the received message, the procedure continues from step 312 directly to step 320. Informing the user may be done by means of a visual indicator, an audible indicator, a mechanical indicator like a buzzer, other, or a combination thereof.

In step 322, a child message display command is received from the user, who has been informed of a new message being available. This step may be omitted if the user is using the application and is reading the applicable thread.

Subsequently, in step 324, the child thread corresponding to the child thread identifier of the message received is displayed on the screen 132 of the second user equipment 130, including the newly received message. This shown in FIG. 4 B, in which in child thread xyz the new message 422 is shown.

In step 326, a hierarchy up command is received by the second user equipment, as discussed in conjunction with the first user equipment 110 and the first flowchart 200. Following this command, objects for the parent thread are obtained in step 328 and the objects are sorted in step 330, preferably by timestamp, as discussed in conjunction with the first flowchart 200 and FIG. 4 C. The object thus sorted, parent thread messages and child thread objects associated with the parent thread abc, are displayed on the screen 132 of the second user equipment 130 in step 332. Subsequently, the procedure end sin a terminator 332.

Having discussed basic procedures of handling messages together with various optional extensions in various embodiments, further embodiments may be envisaged. In professional working environments, like medical environments, legal environment, process production processes, or other, child messages may be created in a parent thread per patient or per medical issue. This allows one group of participants—medical staff of a particular level—to separate discussions per patient from one another, without a need to create a large amount of parent threads with each having their own participant list.

In such scenario, an archiving policy may be associated with the whole parent thread; conversations per patient, each having a dedicated child thread, may be archived on a central server based on data provided in a child thread header or child thread object. With patient data provided in a child thread header or child thread object, full content of a child thread may be exported to an archive. If the thread content is available on the remote server 150, this may be done via the remote server.

In another embodiment, the remote server 150 does not store any data, while in another embodiment, the remote server 150 only stores participant lists and/or child thread objects as discussed above. In that case, a user identified as administrator of a group of participants or any user, may provide a command for archiving and/or data for archiving. Alternatively, the archiving is done automatically, for example via a particular schedule.

In one scenario that may be combined with other embodiments, participants may be added to a list of participants associated with a parent thread—including child threads—while conversations in the parent thread and child threads are ongoing. In one embodiment, the newly added participant may only receive new messages. Via the method depicted by FIG. 3, data on the child thread is provided to the second user equipment 130 used by the newly added participant. In another embodiment, the newly added participant may be provided with historical data, either per request of the new participant, by command of an administrator of the parent thread, automatically, otherwise, or a combination thereof. The historical data may be limited to particular time frame—or not.

In another embodiment that may be combined with other embodiments, data messages in a particular child thread may be deleted after a particular amount of time, as part of a data policy. Such policy ensures privacy of patients that may be discussed in particular child conversations.

Whereas embodiments have been predominantly described in conjunctions with mobile communication devices, the various aspects and embodiments thereof may also be embodied in desktop devices and laptop devices having a physical QWERTY or any other alphanumerical keyboard for any type of character set in Cantonese, Mandarin, Kanji, Cyrillic, Greek, Roman, Arab or Hebrew character set, any other character set or a combination thereof. With the aspects embedded in a desktop—or even a server environment, the devices according to the first and the second aspect do not necessarily comprise a screen; rather, they provide data for a screen to display, either directly or via a terminal computing device.

In summary, a method is provided for providing a message in a child message thread for, for example, an instant message application. The child message thread is associated with a parent thread and preferably with a participant list that comprises at least details of one sender and a receiver of messages of the parent thread and the child thread. In a parent display screen, parent messages may be provided, sorted with objects representing a child thread. By selecting the child thread, messages in the child thread are shown. This concept of nesting of child conversations in a parent conversation allows for convenient and efficient organisation of messages for participants.

In the description above, it will be understood that when an element such as layer, region or substrate is referred to as being “on” or “onto” another element, the element is either directly on the other element, or intervening elements may also be present. Also, it will be understood that the values given in the description above, are given by way of example and that other values may be possible and/or may be strived for.

Furthermore, the invention may also be embodied with less components than provided in the embodiments described here, wherein one component carries out multiple functions. Just as well may the invention be embodied using more elements than depicted in the Figures, wherein functions carried out by one component in the embodiment provided are distributed over multiple components.

It is to be noted that the figures are only schematic representations of embodiments of the invention that are given by way of non-limiting examples. For the purpose of clarity and a concise description, features are described herein as part of the same or separate embodiments, however, it will be appreciated that the scope of the invention may include embodiments having combinations of all or some of the features described. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality.

A person skilled in the art will readily appreciate that various parameters and values thereof disclosed in the description may be modified and that various embodiments disclosed and/or claimed may be combined without departing from the scope of the invention.

It is stipulated that the reference signs in the claims do not limit the scope of the claims, but are merely inserted to enhance the legibility of the claims.

1. In an electronic communication device comprising a memory, a method of processing data messages, the method comprising:
Receiving a user selection of a parent message thread comprising parent messages stored in the memory of the communication device;
Receiving a request for creating a child message thread associated with the parent message thread;
Upon receiving the request, creating a child message thread object;
Associating the child thread object to the parent message thread;
Receiving a user input for displaying objects in the parent message thread;
Providing, for display on a screen, parent display objects representing the parent messages in accordance with a display rule; and
Providing, for display, on the screen, a child thread display object representing the child thread with the parent display objects in accordance with the display rule.

2. Method according to claim 1, further comprising:
Receiving a selection of the child thread;
Providing for display, on the screen, messages of the child thread;
Receiving user input for a new message in the child thread;
Displaying the new message in the child thread; and
Sending, via a communication module comprised by the communication device, the new message to participants, the new message comprising a parent thread identifier and a child thread identifier.

3. Method according to claim 1, wherein the parent thread is associated with a list of conversation participants, the method further comprising associating the child thread with the list of conversation participants.

4. Method according to claim 1, wherein each of the parent messages and the child thread have a time associated with them and the display rule comprising a requirement to sort message by time stamp value.

5. Method according to claim 4, wherein the time stamp associated with the child thread is the time stamp of one of the latest received and the latest created message in the child thread.

6. Method according to claim 1, further comprises sending child message data to at least on intended recipient, the child message data comprising the child message, a parent thread identifier identifying the parent message thread and a child thread identifier identifying the child message thread.

7. In an electronic communication device comprising a memory and a display screen, a method of processing data messages, the method comprising:
Receiving a message comprising a parent thread identifier and a child identifier;
Obtaining a child thread object with an association with the child identifier;
Associating the message with the child thread object;
Receiving a user input for displaying objects in the parent thread;
Providing for display, on the screen, parent display objects representing the parent messages in accordance with a display rule related to object properties; and
Providing for display, on the screen, a child thread display object representing the child thread with the parent display objects in accordance with the display rule.

8. Method according to claim 7, wherein obtaining the child thread object comprises:
Searching the memory for a child thread object by means of the child identifier;
Upon identifying a child thread object corresponding to the child identifier, retrieve the identified child thread object from the memory.

9. Method according to claim 7, wherein obtaining the child thread object comprises:
Searching the memory for a child thread object by means of the child identifier;
Upon failing to find a child thread object corresponding to the child identifier, creating a child thread object and associating the created child thread object with the child identifier.

10. Method according to claim 7, further comprising
Obtaining a timestamp associated with the message; and
Associating the timestamp with the child thread object;
Wherein the display rule comprises a requirement to sort message by time stamp value.

11. Method according to claim 7, further comprising:
Receiving user input selecting the child thread display object;
Providing for display, on the display screen, at least one message of the child message thread.

12. Computer program product comprising computer executable code enabling a computer when programmed by means of the computer executable code to execute the method according to claim 1.

13. Computer program product comprising computer executable code enabling a computer when programmed by means of the computer executable code to execute the method according to claim 7.

14. Electronic communication device comprising:
A memory
A user input module; and
A processing unit;
Wherein the user input module is arranged to:
Receive a user selection of a parent message thread comprising parent messages stored in the memory of the communication device; and
Receive a user request for creating a child message thread associated with the parent message thread; and
Wherein the processing unit is arranged to:
Upon receiving the request, create a child message thread object;
Associate the child thread object to the parent message thread;
Receive a user input for displaying objects in the parent message thread;
Cause a screen to display parent display objects representing the parent messages in accordance with a display rule; and
Cause the screen to display a child thread display object representing the child thread with the parent display objects in accordance with the display rule.

15. Electronic communication device comprising:
A user input module; and
A processing unit;
Wherein the processing unit is arranged to:
Receive a message comprising a parent thread identifier and a child identifier;
Obtain a child thread object with an association with the child identifier;
Associate the message with the child thread object;
Receive, via the user input module, a user input for displaying objects in the parent thread;
Cause a display screen to display parent display objects representing the parent messages in accordance with a display rule related to object properties; and
Cause the screen to display a child thread display object representing the child thread with the parent display objects in accordance with the display rule.
